(19) United States
(12) Patent Application Publication
(10) Pub. No.: US 2025/0342321 A1
(43) Pub. Date: Nov. 6, 2025

(54) PROCESSING, USING GENERATIVE MODEL, CONTENT OF USER INPUT AND TEMPORAL ENCODING FOR THE USER INPUT

(71) Applicant: GOOGLE LLC, Mountain View, CA (US)

(72) Inventor: Dongeek Shin, San Jose, CA (US)

(21) Appl. No.: 18/652,575

(22) Filed: May 1, 2024

(51) Int. Cl. G06F 40/40

(52) U.S. Cl. CPC G06F 40/40

(57) ABSTRACT

Implementations relate to generating, using a generative model (e.g., an LLM), generative model output that reflects a response that is responsive to content of user input and that is responsive to temporal characteristic(s) of providing the user input (e.g., typing speed(s)). Input event(s) that are performed by a user in providing the user input are determined, and temporal features associated with the user input are extracted from the determined input event(s). The generative model is trained to process a combined representation of a content embedding determined from content of the user input and a temporal encoding that encodes the temporal features associated with the user input, in order to generate the response. The generated response thus includes content that varies even when two queries having the same word content are received, if input events for the two queries indicate different user intents.

### BACKGROUND

Generative models, such as large language models (LLMs), are sequence-to-sequence attention-based neural networks with applications in various domains and fields. For example, generative models have been developed and can be used to process natural language (NL) content and/or other input(s), to generate output that reflects generative NL content and/or other generative content that is responsive to the input(s). For instance, an LLM can be used to process NL content of “can I leave dahlias in the ground”, to generate LLM output that reflects a response having several responsive NL sentences, such as: “Dahlias are native to Mexico and Central America, and in zone 8 or above, they are perennial that can be left in the ground over the winter and come back year after year. For Zone 7 and below, dahlias are not frost hardy and are less likely to survive in the ground, and it is probably best to lift and store them in a dark, frost free place until next spring”.

However, LLMs and other generative models often process only the content of user input itself, without any consideration of temporal characteristic(s) of how the user input was provided. For example, if “can I leave dahlias in the ground” is typed user input, tokens of “can I leave dahlias in the ground” will be processed using an LLM in generating LLM output but no temporal characteristic(s) of the typing will be processed using the LLM. For instance, there will be no processing of any indication of how quickly “dahlias” was typed or of the time differential between typing “d” and “a”; “a” and “h”; “h” and “I”; “I” and “i”; “i” and “a”; and “a” and “s” in typing “dahlias”. Accordingly, generative output that is generated, using a generative model based on processing of user input, will not be influenced by temporal characteristic(s) of how the user input was provided. This can result in a response, based on generated generative output, being under specified or over specified. For instance, a user who typed more slowly than usual for the query of “can I leave dahlias in ground” may be a plant newbie and find the aforementioned response containing too much factual information and thus hard to digest, e.g., without looking up definitions for plant hardiness zones, etc. In this case, a response having less factual or authoritative information, such as, “yes, dahlias can be left in the ground during winter if you live in warm places, such as Florida or Hawaii”, or a response providing several options for review by the user can be more appropriate. Put another way, lack of consideration of temporal characteristic(s) of how user input is provided can inhibit the ability of generated generative output to appropriately guide a conversation in accomplishing various technical tasks. However, current utilization of LLMs lack technical features to enable consideration of temporal characteristic(s) of how user input is provided.

### SUMMARY

Implementations disclosed herein relate to using a generative model (e.g., an LLM) in generating a response to user input based on processing, using the generative model, content of the user input (e.g., tokens thereof) as well as a temporal encoding of the user input. The temporal encoding can be generated based on input events that indicate temporal characteristics of providing the user input. For example, the input events for a typed user input can include a corresponding timestamp for the typing of each character of the typed user input, and the temporal encoding can encode the time delay between the typing of each character. For example, if the typed input includes “router” the temporal encoding can encode a first time delay between typing of “r” and typing of “o”, a second time delay between typing of “o” and typing of “u”, etc. The generative model can be trained to be utilized to generate generative output that is dependent not only on content of user input, but that is also dependent on the temporal encoding of such input. For example, the generative model can be trained using supervised fine-tuning (SFT) and/or reinforcement learning with human feedback (RLHF) as described herein.

In these and other manners, both content of user input and a temporal encoding of the user input can be processed, using a generative model, to generate generative output that is dependent on both the content and the temporal encoding. This can result in different generative output, and different corresponding responses, for user inputs having the same content but having differing temporal characteristics. As a non-limiting example, assume typed input of “how to configure Acme router”. For that typed input and first temporal characteristics that indicate fast/confident typing, the generative output can result in a first response that delves directly into technical specifics for configuring the Acme router, such as “navigate to 192.168.1.1; use default admin user name and admin password; set preferred authentication method; . . . .”. In contrast, for that typed input and second temporal characteristics that indicate slow/less confident typing, the generative output can result in a second response that is more explanatory such as “open a web browser then type, in the address bar of the web browser, 192.168.1.1; you will then be prompted with a login screen . . . ”. As another contrasting example, for that typed input and third temporal characteristics that indicate fast/confident typing for all characters but for those characters of “Acme”, the generative output can result in a response that is akin to the first response but, unlike the first response, also includes a prompt at the end of “let me know if you'd like instructions for other routers beside the Acme router”.

Accordingly, through consideration of the temporal encoding for user input, along with the content of the user input itself, implementations disclosed herein can enable generation of generative output in appropriately guiding a conversation in accomplishing various technical tasks.

Some implementations disclosed herein encode a user intent of a user input from a user based on input event(s) associated with the user input. Implementations disclosed herein may further relate to generating a response to the user input, in dependence on the encoded user intent and using a generative model, such as a large language model (LLM). In various implementations, the input event(s) can reflect a user intent, such as a level of confidence of the user in providing the user input. In some implementations, for a first user intent (e.g., a low level of confidence in providing the user input), the response generated using the generative model described in this disclosure, for instance, can be of a limited length, can include a limited amount of factual or authoritative information, can be more explanatory, and/or can include several options (e.g., different responses for choose/review by the user). In some implementations, for a second user intent (e.g., a high level of confidence in providing the user input), the response generated using the generative model, for instance, can include a predefined amount of factual or authoritative information (e.g., at least a predefined number of factual statements/sentences, etc.).

In some implementations, for a third user intent (e.g., a low level of confidence in providing a particular word, phrase, or other portion, of the user input), the response generated using the generative model, for instance, can include one or more descriptions of the particular word (or phrase, etc.), or can include a prompt asking the user whether additional information for the particular word (or phrase, etc.) is needed. In these manners, different responses can be generated and rendered in response to user inputs that have the same content (e.g., word content) but are associated with different user intents derived from different input events respectively associated with the user inputs.

By formulating a response responsive to a user input to include more factual or authoritative information/content in case input event(s) of the user input indicate a high level of confidence and formulating a response including less factual or authoritative information/content in case the input event(s) indicate a low level of confidence, different informational needs for different users (or the same user in different scenarios or at different moments) can be satisfied. Moreover, by providing different responses having different lengths and/or complexity of content for queries having the same word content but associated with different user intents (as reflected by temporal characteristics of the user input that provide the queries), computational resources and other associated resources (e.g., battery, network, etc.) can be utilized or allocated appropriately. In some implementations, providing multiple options in response to a user query having a relatively low user confidence indicated by input event(s) associated with the user query may reduce a duration of human-to-computer dialog between the user and an intelligent assistant (also referred to as “chatbot”, etc.) that accesses or utilizes the LLM. This results in reduced consumption of computational resources, network resources, etc.

In some implementations, the user input can be a typed user input (sometimes referred to as “typed input”), and the input event(s) can include one or more typing events associated with the typed user input. In some implementations, the user input can be a spoken user input (sometimes referred to as “spoken input”), and the input event(s) can include one or more utterance events associated with the spoken user input. In some other implementations, the user input can be of other types. For example, the user input can be a touch input, a handwritten input, a gesture input or other motion input, etc. Correspondingly, the input event(s) can, additionally, or alternatively, include other types of events, such as touch event(s), gesture-capturing motion event(s), etc. The present disclosure, however, is not intended to be limiting.

In some implementations, temporal features (e.g., speed, time intervals, etc.) associated with the user input can be extracted from the input event(s) associated with the user input, to determine, or assist in determining, the user intent. For example, temporal features indicating a high input speed of the user input can indicate a high level of confidence of a user in providing the user input, which further indicates a user intent for receiving a response having a high amount of factual or authoritative information. In some implementations, an input speed of the user input can be considered as a “high” input speed if such input speed is faster than an average input speed of the user, where the average input speed of the user may be determined based on one or more input instances acquired from the user. The average input speed may be included/saved in a user profile of the user, or can be stored in association with the user. In some other implementations, an input speed of the user input can be considered as a “high” input speed if such input speed exceeds a predefined input speed threshold.

As a non-limiting example, typing event(s) reflecting a high typing speed of the typed user input (or a specific portion thereof) can be utilized to determine or indicate a high level of confidence of the user (“high user confidence”) in providing the typed user input (or the specific portion thereof). This can indicate a user intent that desires authoritative or factual information responsive to the user input (or the specific portion thereof). In this case, a generative model (e.g., LLM) can be trained and utilized to generate a response containing factual or authoritative information determined based on a level of confidence indicated by the typing event(s). For instance, the generative model can be trained and utilized to generate a response full of factual or authoritative information in response to a typed user input created by typing event(s) that indicate a high level of confidence of the user in providing the typed user input. In some implementations, the generative model can be trained using a reinforcement learning with human feedback (RLHF) approach.

As another non-limiting example, an utterance event of a user that provides a spoken input can indicate a speaking speed of the user slower than usual. Based on such utterance event, a low level of confidence of the user (“low user confidence”) in providing the spoken input may be determined, and thus a user intent to receive less factual or authoritative content. In this case, the generative model can be trained and utilized to generate a response having a limited length, a limited amount of authoritative or factual information, and/or one or more options for review (or selection) by the user, etc.

The above non-limiting examples and various other examples can be realized, for instance, by encoding temporal feature(s) that usually reflect a user intent of a user input and that are extracted from input event(s) associated with the user input, and by providing the encoded temporal feature(s) to the generative model along with the word content of the user input. This enables response(s) generated using the generative model to vary based on different user intents even for user queries having the same word content. As a result, a response generated using the generative model disclosed herein can include more authoritative information to a first user query resulted from a first set of input events from a first user, and include less authoritative information to a second user query resulted from a second set of input events from a second user. In some implementations, the first user query and the second use query can, but do not necessarily need to, share the same word content. In some implementations, the first user query and the second user query can be created via different input events (e.g., the first set of input events and the second set of input events) that show different temporal features with respect to each other. The temporal features can be character-based, word-based, phoneme-based, motion-based, gesture-based, etc., and the present disclosure is not limited thereto.

In various implementations, a computer-implemented method is provided, where the method includes: receiving a typed user input that includes one or more words; determining one or more typing events associated with the typed user input; mapping the typed user input to an embedded representation of the typed user input; combining the embedded representation of the typed user input with a temporal encoding determined based on the one or more typing events associated with the typed user input, to generate a combined embedded representation (may also be referred to as “combined representation”) of the typed user input; processing the combined embedded representation, using a machine learning model, to generate model output from which a response responsive to the typed user input is derived; and causing the response derived from the model output of the machine learning model, to be rendered via an output device, in response to the typed user input.

In some implementations, the temporal encoding can be, but does not necessarily need to be, a temporal embedding in the format of a numerical vector. In some implementations, the typed user input can be received at an input device, such as a keyboard, etc. The output device can be, for instance, a display. The input device and the output device can be, but do not necessarily need to be, coupled, or integrated, to the same computing device (e.g., laptop, cellphone, etc.). In other words, the input device and the output device can be at different computing devices.

In some implementations, determining typing events associated with the typed user input includes: determining a receiving time for each character in the one or more words at the input device. In some implementations, the temporal encoding (or the temporal embedding) determined based on the typing events is an inter-character temporal encoding/embedding that encodes time intervals between each two adjacent characters in the typed user input.

In some implementations, additionally or alternatively, determining typing events associated with the typed user input includes: determining a typing speed of the typed user input. In some implementations, additionally or alternatively, the temporal encoding/embedding determined based on the typing events encodes the typing speed of the typed user input. In some implementations, the typing speed of the typed user input can be a dynamic value that varies from one portion of the typed user input to another. For instance, the typing speed of the typed user input can vary from one word (of the one or more words) to another. In some implementations, the temporal encoding can encode the typing speed that varies from one word to another.

In some implementations, content of the response generated using techniques described herein varies in dependence on the temporal encoding. In some implementations, the response includes more authorized content when the temporal encoding indicates a high user confidence in the typed user input, and includes less authorized content when the temporal encoding indicates a low user confidence in the typed user input. In some implementations, the machine learning model includes a decoder, and the model output is text-token specific.

The preceding is presented as an overview of only some implementations disclosed herein. These and other implementations are disclosed in additional detail herein. For example, additional and/or alternative implementations are disclosed herein such as receiving, via an input device, a spoken user input that includes one or more words; determining spoken events associated with the spoken user input; mapping the spoken user input to an embedded representation of the spoken user input; combining the embedded representation of the spoken user input with a temporal encoding determined based on the spoken events associated with the spoken user input, to generate a combined representation of the spoken user input; processing the combined representation, using a machine learning model, to generate model output from which a response responsive to the spoken user input is derived; and causing the response derived from the model output of the machine learning model, to be rendered via an output device, in response to the spoken user input.

As another example, additional and/or alternative implementations are disclosed herein such as generating a plurality of training instances, and utilizing the plurality of training instances to train or fine-tune a generative model to possess a capability of responding differently to two queries having the same query content but received via input events having different temporal characteristics.

As a further example, additional and/or alternative implementations are disclosed herein such as training the generative model to provide different responses that recommend different actions (and/or content) in response to two queries having the same query content but received with input events having different temporal characteristics.

Various implementations can include a non-transitory computer readable storage medium storing instructions executable by a processor to perform a method such as one or more of the methods described herein. Yet other various implementations can include a system including memory and one or more hardware processors operable to execute instructions, stored in the memory, to perform a method such as one or more of the methods described herein.

### BRIEF DESCRIPTION OF THE DRAWINGS

FIG. 1A depicts a block diagram of an example environment that demonstrates various aspects of the present disclosure, and in which some implementations disclosed herein can be implemented.

FIG. 1B and FIG. 1C illustrate an example scenario where a response is generated in response to user input using a framework in accordance with various implementations disclosed herein.

FIG. 2A depicts an example of human-to-computer dialog where a first response is generated in response to a user query, in accordance with various aspects of the present disclosure.

FIG. 2B depicts an example of human-to-computer dialog where a second response is generated in response to the user query in FIG. 2A, in accordance with various aspects of the present disclosure.

FIG. 2C depicts an example of typing events, in accordance with various aspects of the present disclosure.

FIG. 2D depicts examples of character-level time intervals between different characters determined from different typing events for the same user input, in accordance with various aspects of the present disclosure.

FIG. 3 depicts an example of a response generated using a trained generative model and considering a user intent reflected from typing events associated with typed user input, in accordance with various aspects of the present disclosure.

FIG. 4 depicts a flowchart illustrating an example method of generating a response using a generative model, in accordance with various aspects of the present disclosure.

FIG. 5 depicts an example architecture of a computing device, in accordance with various implementations.

### DETAILED DESCRIPTION

The following description with reference to the accompanying drawings is provided for understanding of various implementations of the present disclosure. It's appreciated that different features from different implementations may be combined with and/or exchanged for one another. In addition, those of ordinary skill in the art will recognize that various changes and modifications of the various implementations described herein can be made without departing from the scope and spirit of the present disclosure. Descriptions of well-known or repeated functions and constructions may be omitted for clarity and conciseness.

The terms and words used in the following description and claims are not limited to the bibliographical meanings, and are merely used by the inventor to enable a clear and consistent understanding of the present disclosure. Accordingly, it should be apparent to those skilled in the art that the following description of various embodiments of the present disclosure is provided for the purpose of illustration only and not for the purpose of limiting the present disclosure as defined by the appended claims and their equivalents.

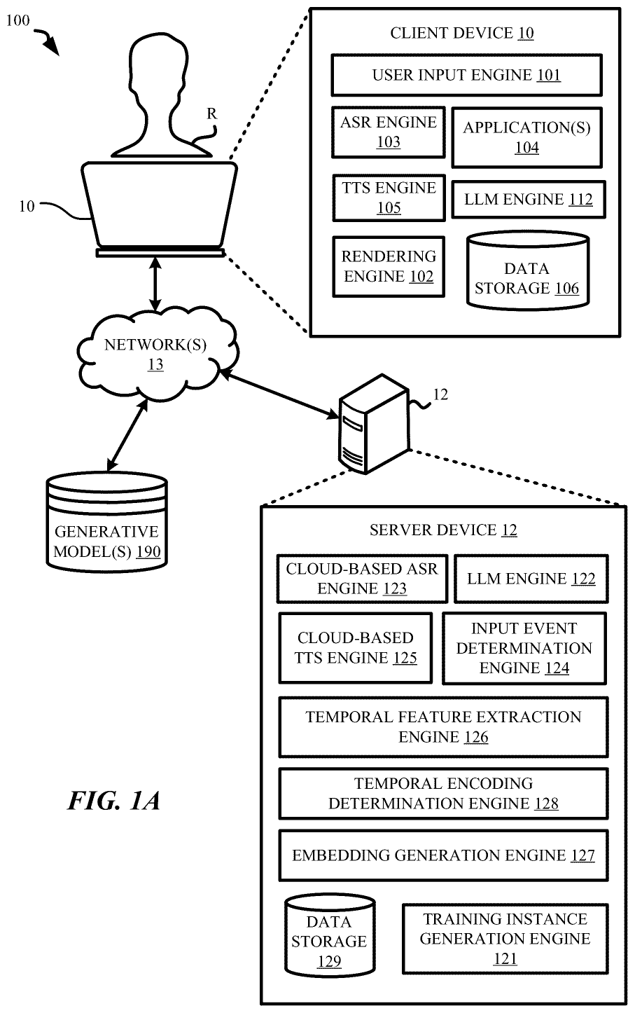

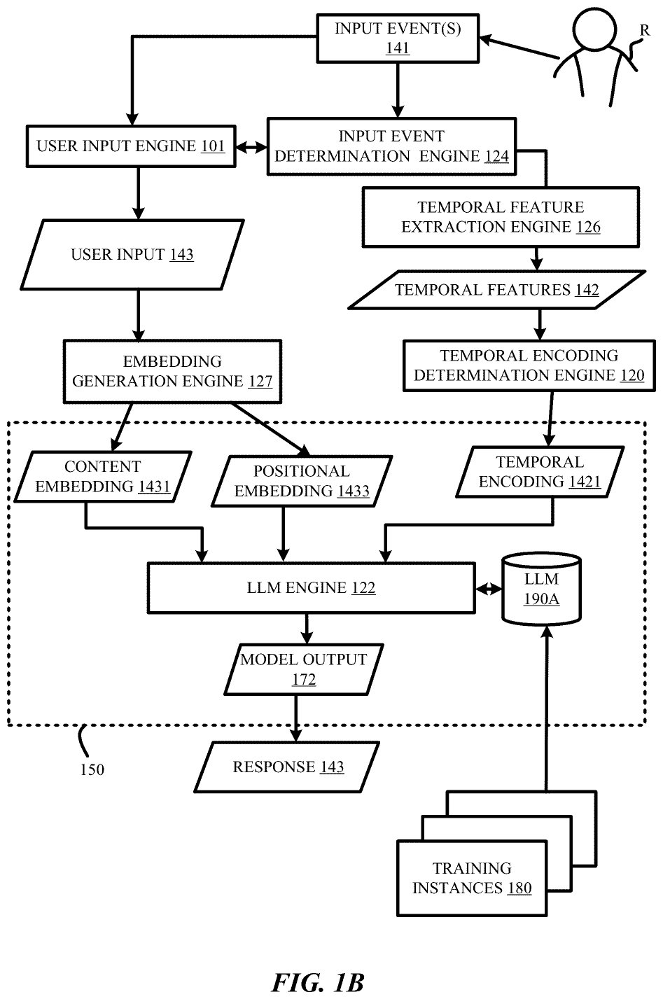

FIG. 1A is a block diagram of an example environment 100 that demonstrates various aspects of the present disclosure, and in which implementations disclosed herein may be implemented. As shown in FIG. 1A, the environment 100 can include a client computing device 10 (“client device”), and a server computing device 12 (“server device”) that is in communication with the client computing device 10 via one or more networks 13. The one or more networks 13 can include, for example, a local area network (LAN), a wide area network (WAN) such as the Internet, and/or any other appropriate network.

The client computing device 10 can be, for example, a desktop computing device, a laptop computing device, a tablet computing device, a mobile phone computing device, a computing device of a vehicle (e.g., an in-vehicle entertainment system), an interactive speaker, a smart appliance such as a smart television, and/or a wearable apparatus that includes a computing device (e.g., glasses having a computing device, a smart watch, a virtual or augmented reality computing device), and the present disclosure is not limited thereto.

In various implementations, the client computing device 10 can include a user input engine 101 that is configured to detect user input provided by a user (e.g., user R) of the client computing device 10. The user input may be provided by the user using one or more user interface input devices, such as a keyboard, a touch screen, a microphone, etc. The user input can be typed input, touch input, audible input, or any other applicable type of input. For example, the client computing device 10 can be equipped with a keyboard to receive typed input, and/or a mouse (or one or more hardware buttons) to receive a user click that selects one or more graphical user interface (GUI) elements that is rendered visually at a user interface of the client computing device 10. Additionally, or alternatively, the client computing device 10 can be equipped with one or more microphones that capture audio data, such as audio data capturing spoken utterances of the user and/or other sounds in an environment of the client computing device 10. Additionally, or alternatively, the client computing device 10 can be equipped with one or more vision components that are configured to capture vision data corresponding to images and/or movements (e.g., gestures) detected in a field of view of one or more of the vision components. Additionally, or alternatively, the client computing device 10 can be equipped with one or more touch sensitive components (e.g., a stylus, a touch screen, a touch panel, etc.) that are configured to capture signal(s) corresponding to touch input that is directed to the client computing device 10.

In some implementations, the user input engine 101 can include, or otherwise in communication with an input event determination engine (e.g., a cloud-based input event determination engine 124). The input event determination engine 124 can be configured to determine one or more input events associated with a user input. The one or more input events can be, or can include, for instance, a typing event in which a physical key of a physical keyboard is typed, a touch event in which a virtual key of a virtual keyboard is selected, an utterance event in which a user speech is received, a gesture event in which a gesture is received, etc.

In some implementations, the input determination engine 124 can be configured to determine a receiving time for each character (or word) present in the user input. The receiving time for each character (or word) in the user input can be determined using the aforementioned one or more user interface input devices or sensor(s) thereof. The sensor(s) of the one or more use interface input devices can be, or can include, touch sensor(s) of a touch screen, magnetic sensor(s) for detecting a key press at a keyboard, sound sensor(s) of a microphone, motion sensor(s) for detection a movement or gesture of a user, etc. In some implementations, a time interval between two characters (or between two words) can be determined. The time interval between two adjacent characters (or two adjacent words) in the user input can be determined, for instance, based on the receiving time for each character (or word) present in the user input. In some implementations, other temporal features of the user input can be extracted from the input event(s). The temporal features of the user input extracted from the input event(s) can be applied to indicate a user intent, such as a level of confidence of a user in providing the user input. Such temporal features may further be utilized to vary response(s) generated using a generative model (e.g., large language model, “LLM”), so that the response(s) can match/reflect the user intent, e.g., the level of confidence of the user in providing the user input. More details will be provided later in this disclosure.

In various implementations, the client computing device 10 can include a rendering engine 102, one or more applications 104 installed locally at (or otherwise accessible via) the client computing device 10, and/or a data storage 106. In various implementations, the rendering engine 102 can be configured to provide content for audible and/or visual presentation to a user of the client computing device 10 using one or more user interface output devices. For example, the client computing device 10 can be equipped with one or more speakers that enable content (e.g., “Lilies are often toxic to dogs, but Canna lilies are an exception”) to be provided for audible presentation to the user via the client computing device 10. Additionally, or alternatively, the client computing device 10 can be equipped with a display or projector that enables content (e.g., “would you like to see a photo of irish wolfhound”) to be provided for visual presentation to the user via the client computing device 10.

The data storage 106, and/or a data storage 129 at the server device 12, can store various types of files and/or data. For instance, the data storage 106 can store metadata (e.g., a user profile of user R, etc.) associated with the one or more applications 104 and/or associated with the client computing device 10. Additionally, or alternatively, in some implementations, the data storage 106 can store a plurality of training instances (e.g., 180 in FIG. 1B) to train or fine-tune the aforementioned generative model. As described above, the generative model can be, for instance, an LLM. The LLM can include, for instance, one or more decoder neural networks (may shortly be referred as “decoder”) and/or one or more encoder neural networks (may shortly be referred to as “encoder”). In some implementations, the encoder can be customized/trained to encode not only word content and/or positional information associated with a user input, but also further encode the aforementioned temporal features extracted from input event(s) that create/deliver the user input, resulting in a combined representation (e.g., a combined encoding or a combined embedding) for the user input being generated. More descriptions about the combined representation will be provided later in this disclosure. In some implementations, the combined representation for the user input can be processed using the decoder (after being trained or fine-tuned) to generate one or more model output from which a response to the user input can be derived and/or rendered. Such one or more model output of the decoder, for instance, can be text token-specific. The decoder, for instance, can be trained using enormous amounts of data collected from diverse sources such as webpages, electronic books, software code, electronic news articles, and/or machine translation data.

In some implementations, training of the generative model (e.g., LLM) can be performed through supervised learning and/or reinforcement learning. The reinforcement learning can be, for instance, reinforcement learning from human feedback (“RLHF”) that incorporates human feedback into the training of the LLM to align output of the LLM with human preferences (e.g., responses with more factual information for user input(s) having a low level of confidence, and responses with less factual information for user input(s) having a high level of confidence). This can be implemented using a reward model trained based on human feedback. For instance, for a given user input and a plurality of responses responsive to the given user input, a human reviewer can indicate a preference (e.g., in the form of a scalar score) for each of the plurality of responses. In other words, the plurality of response for the given user input can be ranked in an order from highest human preference (indicated by a highest scalar score) to lowest human preference (indicated by a lowest scalar score). In some implementations, the scalar scores assigned by the human reviewer to the plurality of responses for the given user input can satisfy a Gaussian distribution with an average value of approximately “0”, where the scalar score(s) for response(s) of higher human preference should be positive and increase with the increasing of human preference and the scalar score(s) for response(s) of lower human preference should be negative and decreases with the decreasing of human preference.

The scalar score can be applied as a reward in the RLHF process, where a large value of the scalar score indicates a higher quality of a corresponding response more preferred by the human reviewer a lower value of the scalar score indicates a higher quality of a corresponding response that is less preferred by the human reviewer. In some implementations, such given user input and the plurality of responses responsive to the given user input can be stored in the data storage 106 as one instance for training the reward model. In some implementations, a limited number of instances are manually curated and/or stored in the data storage 106, to train the reward model.

In various implementations, the client computing device 10 can further include a plurality of local components. The plurality of local components can include, for instance, an automatic speech recognition (ASR) engine 103 and/or a text-to-speech (TTS) engine 105. Additionally or alternatively, the plurality of local components can include other component(s) such as a prompt-generating engine, and/or an LLM engine 112.

In some implementations, the one or more applications 104 can include an LLM-based assistant (may also be referred to as “assistant”, “chatbot”, etc., not illustrated in FIG. 1A). The ASR engine 103, the TTS engine 105, the prompt-generating engine, and/or the LLM engine 112 may be (but does not necessarily need to be) included in the LLM-based assistant. In some implementations, a user (e.g., user R) of the client computing device 10 may have a registered account associated with the LLM-based assistant and/or other application(s). The other applications can include, for example, a social media application, a video player, a note-taking application, a shopping application, a messaging application, and/or any other appropriate applications (or services), installed at, or accessible via, the client computing device 10.

The server computing device 12 can be, for example, a web server, one or more blade servers acting together to provide “cloud” infrastructure, or any other type of server as needed. In various implementations, the server computing device 12 can include cloud-based components the same as or similar to the plurality of local components installed at the client computing device 1. For example, the server computing device 12 can include a cloud-based ASR engine 123, a cloud-based TTS engine 125, a cloud-based prompt-generating engine 120, and/or a cloud-based LLM engine 122. In some implementations, the server computing device 12 can further include a training instance generation engine 121. The training instance generation engine 121 can be applied to generate training instances to train the aforementioned generative model (e.g., LLM 190A in FIG. 1B), and/or to generate instances to train the aforementioned reward model (e.g., 190B in FIG. 1B). As described above, the generative model can be trained, e.g., via RLHF using the reward model, to be capable of processing a user query considering a user intent that is parsed/determined from input event(s) associated with the user query.

The ASR engine 103 (and/or the cloud-based ASR engine 123) can process, using one or more streaming ASR models (e.g., a recurrent neural network (RNN) model, a transformer model, and/or any other type of ML model capable of performing ASR), streams of audio data that capture spoken utterances, to generate corresponding streams of ASR output. The ML model(s) can be on-device ML models that are stored locally at the client computing device 10, remote ML models that are executed remotely from the server computing device (e.g., at remote server device 12), or shared ML models that are accessible to both the client computing device 10 and/or remote systems (e.g., the remote server computing device 12). The audio data can be acquired from audio recordings or can be generated by microphone(s) of the client computing device 10. Notably, the streaming ASR model can be utilized to generate the corresponding streams of ASR output as the streams of audio data are generated.

In some implementations, the corresponding streams of ASR output can include, for example, streams of ASR hypotheses (e.g., term hypotheses and/or transcription hypotheses) that are predicted to correspond to spoken utterance(s) of a user that are captured in the corresponding streams of audio data, one or more corresponding predicted measures (e.g., probabilities, log likelihoods, and/or other values) for each of the ASR hypotheses included in the streams of ASR hypotheses, a plurality of phonemes that are predicted to correspond to spoken utterance(s) of a user that are captured in the corresponding streams of audio data, and/or other ASR output. In some versions of those implementations, the ASR engine 103 and/or 123 can select one or more of the ASR hypotheses as corresponding recognized text (“transcript”) that corresponds to the spoken utterance(s) (e.g., selected based on the corresponding predicted measures).

In some versions of the implementations, the ASR engine 103 and/or 123, in cooperation with the input event determination engine 124, can determine a time-stamp (e.g., receiving time) for each phoneme in the plurality of phonemes that are predicted to correspond to the spoken utterance(s) of the user, or can determine time interval/delay between each pair of adjacent phonemes within the plurality of phonemes. In some implementations, the time-stamps of the phonemes and/or the time intervals between phonemes can be utilized to generate temporal encoding(s), either a single temporal encoding or a sequence of temporal encodings (sometimes referred to as “temporal encoding sequence”), for the spoken utterance(s) of the user. Such temporal encodings can be combined with other encodings or embeddings (e.g., token embedding(s) and/or positional embedding(s)), to generate a combined representation for processing using the generative model. More detailed descriptions can be found later in this disclosure.

The TTS engine (e.g., 105 and/or 125) can process, using TTS model(s), corresponding streams of textual content (e.g., content generated based on LLM or a predetermined text, etc.) to generate synthesized speech audio data that includes computer-generated synthesized speech. In additional or alternative implementations, the synthesized speech audio data can be pre-cached in memory or in one or more databases accessible by the client computing device 10.

In some implementations, the LLM engine 112 can be in communication with one or more generative models 190 (e.g., LLM 190A FIG. 1B), for a user query to be processed using the generative model 190. In some implementations, the LLM engine 112 can include an embedding generation engine (e.g., 126), where an embedding generation engine 127 generates an input embedding (sometimes referred to as “input representation”, “token embedding”, “content embedding”, “content representation” etc.) that encodes word content of a user input and a positional embedding that encodes relative positions between words or tokens in the user input. A “token” refers to a unit of text data for processing using the generative models 190, and can correspond to a word, one or more characters of a word. In some implementations, a token can include not only character(s) but also punctuation(s), space(s), and/or emojis.

As a non-limiting example, a user input of “who's that” can be tokenized into a plurality of tokens, including a first token of “who”, a second token of “'s”, and a third token of “that”. In this example, the input embedding that encodes the word content of the user input of “who's that” can be generated based on the plurality of tokens. In some implementations, the input embedding can be an N-dimensional numerical vector (e.g., [0.0012567 . . . , −0.2368598 . . . , . . . , . . . ]) storing a total number of N floating point numbers, where N can be in the order of hundreds, thousands, etc. The N-dimensional numerical vector can be a token representation of the plurality of tokens in a latent space, that corresponds to the word content of the user input. In this example, a positional embedding can be generated based on relative positions of the tokens in the plurality of tokens, so as to encode/reflect the relative positions between the tokens or words in the user input. The positional embedding can also be configured in the form of an N-dimensional numerical vector storing a sequence of floating point numbers, so that the positional embedding can be combined with the input embedding and/or other embedding(s) (e.g., the temporal embedding or encoding), for processing using the generative model.

In some implementations, the prompt-generating engine of the client computing device 10 (or the prompt-generating engine 120 of the server device 12) can be configured to generate a prompt (e.g., textual prompt) to be processed as input using one of the generative models 190. In some implementations, the prompt-generating engine 110 can be included in the LLM engine 112.

In various implementations, the one or more generative models 190 can include a large language model (LLM) having less than 100 billion parameters, more than 100 billion parameters, or over 200 billion parameters, etc. The greater the number of parameters of an LLM, the more complex (or sophisticated) a task (e.g., specified in a user query or request) the LLM can handle. The LLM may be stored at client computing device 10, or at the server computing device 12. For instance, if the memory of the client computing device 10 restricts the storing of the LLM at the client computing device 10 or if a length of a textual prompt to be processed using the LLM exceeds a predetermined token length, the LLM may be stored at the server device 12. For instance, if the memory of the client computing device 10 does not restrict the storing of the LLM at the client computing device 10, the LLM may be stored at the client computing device 10, to reduce a latency in completing a task (e.g., specified in the user query or request), for instance, by avoiding data communications via the one or more networks 13.

In some implementations, when the generative model 190 is stored at the client computing device 10, the maximum token length of content (e.g., text) processable using the LLM may be a first maximum token length (e.g., 10,000). In some implementations, when the LLM is stored at the server device 12, the maximum token length of content (e.g., text) processable using the generative model 190 may be a second maximum token length (e.g., 30,000) that is greater than the first maximum token length. The maximum token length can be a maximum number of tokens (which can be parsed from a user input) that is allowed for processing, in a single iteration, using the generative model 190.

In some implementations, the LLM can be transformer-based. One non-limiting example of an LLM is GOOGLE'S Pathways Language Model (PaLM). Another non-limiting example of an LLM is GOOGLE'S Language Model for Dialogue Applications (LaMDA).

In some implementations, the server computing device 12 (or the client computing device 10) can further include an input event determination engine 124, a temporal feature extraction engine 126, an embedding generation engine 127 and/or a temporal embedding determination engine 128. As described above, the input event determination engine 124 can be configured to determine one or more input events associated with a user input. The temporal feature extraction engine 126 can be configured to extract temporal features (e.g., receiving time, time intervals, etc.) of the user input from the one or more input events. The embedding generation engine 127 can be configured to generate content embedding (“input embedding”) of the user input that encodes word content of the user input, and/or to generate a positional embedding that encodes positions of words (e.g., an order of the words) in the user input. In some implementations, the temporal encoding determination engine 128 can be part of the embedding generation engine 127. The temporal encoding determination engine 128 can be configured to generate a temporal encoding that encodes the temporal features of the user input.

For example, the user input can be a typed user input received by a computing device from user R via a physical keyboard. In this example, the input event determination engine 124 can be configured to determine/record an initial moment at which a first word (or character) of the typed user input is received at the physical keyboard, a last moment at which a last word (or character) of the typed user input is received at the physical keyboard. Additionally or alternatively, the input event determination engine 124 can determine a receiving time for each word (and/or each character) in the typed user input. The input event determination engine 124, for instance, can utilize sensors (e.g., magnetic sensors and/or timing sensor) to sense a press on a mechanical key of a physical keyboard, and to determine a time-stamp (e.g., indicating a receiving time) of a character that the mechanical key corresponds. In this case, the input event determination engine 124 can determine an order of characters (or words) in the typed user input and a receiving time for each character (or word) in the typed user input. Based on the order of characters (words) and the receiving time for each character (or each word) in the typed user input, the temporal feature extraction engine 126 can determine/extract temporal features, such as a time interval between each two adjacent characters (or each two adjacent words) and/or a typing speed (dynamic or average) of the typed user input.

As another example, the user input can be a touch user input received by a computing device from user R via a virtual keyboard displayed via a touch screen of the computing device. In this example, the input event determination engine 124 can be configured to determine/record an initial moment at which a first word or character of the touch user input is received at the touch screen, a last moment at which a last word or character of the touch user input is received at the touch screen, and/or a receiving time for each word and/or each character in the touch user input. The input event determination engine 124, for instance, can utilize sensors (e.g., pressure sensors) to sense a difference in pressure on a portion of the touch screen that corresponds to a key of the virtual keyboard, to determine a receiving time of a character that the key of the virtual keyboard corresponds to. In this case, the input event determination engine 124 can determine an order of characters (or words) in the touch user input and a receiving time for each character (or word) in the touch user input. Based on the order of characters (words) and the receiving time for each character (or each word) in the touch user input, the temporal feature extraction engine 126 can determine/extract temporal features, such as a time interval between each two adjacent characters (or each two adjacent words) and/or a typing speed (dynamic or average) of the touch user input.

As a further example, the user input can be a spoken user input received by a computing device from user R via a microphone of the computing device. In this example, the input event determination engine 124 can be configured to determine/record an initial moment at which a first word (or character) of the spoken user input is received at the microphone, a last moment at which a last word (or character) of the spoken user input is received at the microphone, and/or a temporal sequence for phonemes of word(s) predicted for the spoken user input. The input event determination engine 124, for instance, can communicate with the ASR engine, to determine a time stamp for each phoneme in the spoken user input. In this case, the temporal feature extraction engine 126 can extract/determine a time interval between each two adjacent phonemes in the spoken user input and/or a speaking rate (dynamic or average) of the spoken user input.

FIG. 1B and FIG. 1C illustrate an example scenario where a response is generated in response to user input using a framework in accordance with various implementations disclosed herein. As shown in FIG. 1B, one or more input events 141 performed by a user R to provide a user input 143 can be detected by the user input engine 101 and/or the input event determination engine 124 as being received at a client device (e.g., a tablet, a smart phone, etc.). The user input engine 101 can determine content (e.g., word content, emoji, drawing, etc.) of the user input 143. The input event determination engine 124 can determine and/or classify the one or more input events 141.

In some implementations, the user event determination engine 124 can determine an order of characters, words, phonemes associated with one or more words, or gestures, etc. based on the one or more input events 141, and forward such determined order to the user input engine 101 to facilitate the determination of the content of the user input 143.

In some implementations, the temporal feature extraction engine 126 can be in communication with the input event determination engine 124, to extract temporal features 142 associated with the user input 143 from the one or more input events 141. The temporal features 142 associated with the user input can include or indicate, for instance, an average input speed of the user input. For instance, the temporal features 142 associated with the user input can include an initial time at which a first word (or character) of the user input is received, and/or an ending time at which a last word (or character) of the user input is received. In this case, the average input speed of the user input can be determined based on the initial time (at which the first word or character is received) and the ending time (at which the last word or character is received).

Alternatively or additionally, the temporal features 142 associated with the user input can include or indicate a dynamic input speed of the user input showing variance of input speed across different portions (e.g., characters, words, phonemes, gestures, etc.) of the user input. Alternatively or additionally, the temporal features 142 associated with the user input can include a time interval between one or more pairs of adjacent words (or characters, gestures, emojis, etc.) in the user input. In some implementations, the temporal features 142 associated with the user input can include a time interval between each pair of two adjacent words in the user input. For instance, assuming the user input is a typed input of “Which mountain is the tallest”, the temporal features 142 associated with the user input 143 can include a first time interval between the word “which” and the word “mountain”, a second time interval between the word “mountain” and “is”, a third time interval between the word “is” and the word “the”, and/or a fourth time interval between the word “the” and the word “tallest”.

Alternatively or additionally, the temporal features 142 associated with the user input 143 can include a time interval between two adjacent characters in the user input 143. In some implementations, the temporal features 142 associated with the user input 143 can include a time interval between each two adjacent characters in the user input 143. For instance, assuming the user input 143 is a touch input of “who is highest”, the temporal features 142 associated with the user input 143 can include a first time interval between the character “w” and the character “h”, a second time interval between the character “h” and the character “o”, a third time interval between the character “o” and the character “i”, a fourth time interval between the character “i” and the character “s”, a fifth time interval between the character “s” and the character “t”, a sixth time interval between the character “t” and the character “a”, a seventh time interval between the character “a” and the character “l”, an eighth interval between the character “l” and the character “l”, a ninth time interval between the character “I” and the character “e”, a tenth time interval between the character “e” and the character “s”, and an eleventh time interval between the character “s” and the character “t”.

In some implementations, the embedding generation engine 127 can process the content of the user input 143 to generate a content embedding 1431 that encodes the content of the user input 143 and a positional embedding 1433 that encodes positions (e.g., relative positions) of words (or tokens) in the user input 143. The temporal encoding determination engine 128 can process the temporal features associated with the user input to generate a temporal encoding 1421 that encodes the temporal features 142 associated with the user input 143. In some implementations, optionally, the content embedding 1431, the positional embedding 1433, and/or the temporal encoding 1421 can each be an N-dimensional numeric vector (or a sequence of N-dimensional numeric vectors) in a latent space. An N-dimensional numeric vector can store a total of N float numbers arranged in an order.

In some implementations, the LLM engine 122 can combine the content embedding 1431, the positional embedding 1433, and the temporal encoding 1421, to generate a combined representation associated with the user input 143. The combined representation can be processed using an LLM 190A, to generate a model output 172 from which a response 145 responsive to the user input 143 can be derived. The LLM 190A can be trained using a large set of diverse data and be fine-tuned or customized using one or more training instances 180.

In some implementations, training of the LLM 190A is realized via supervised training and/or reinforcement training. The reinforcement training can be reinforcement learning from human feedback (“RLHF”) that incorporates human feedback into the training of the LLM to align output of the LLM with human preferences, as described above. For instance, the RLHF can utilize a reward model trained using a limited number of instances each including a user input and a plurality of responses ranked based on a scalar score assigned to each of the plurality of responses by a human reviewer. The limited number of instances can be manually curated or collected from different resources, such as public forums or feedback provided by human users.

A more detailed view of a process 150 that shows the processing of the combined representation for the user input 143, using the LLM 190A, can be found in FIG. 1C. In some implementations, referring to FIG. 1C, the LLM 190A can include an encoder having one or more encoder sub-networks (e.g., each including an encoder self-attention sub-layer 1901), and/or a decoder having one or more decoder sub-networks (e.g., each including a decoder self-attention sub-layers 1903). In some implementations, the combined representation (that combines the content embedding 1431, the positional embedding 1433, and the temporal encoding 1421) can be provided to an encoder self-attention sub-layer (labeled “multi-head attention”) 1901 of a first encoder sub-network of the LLM 190A. The encoder self-attention sub-layer 1901 can be configured to apply an attention mechanism (e.g., a multi-head attention mechanism) to the combined representation, to generate one or more encoder self-attention sub-layer outputs. The attention mechanism can be implemented, for instance, via one or more matrix multiplications. In some implementations, the first encoder sub-network of the LLM 190A can further include a connection layer and a normalization layer (collected referred to as “add&norm 1902”). The connection layer can combine the one or more encoder self-attention sub-layer outputs, to generate a combined encoder self-attention sub-layer output. The normalization layer can normalize the combined encoder self-attention sub-layer output, to generate a first encoder output. The first encoder output can be processed by additional encoder self-attention sub-layer(s) 1901, if there is any, to generate a final encoder output.

In some implementations, the decoder of the LLM 190A can include one or more decoder sub-networks 1903, a linear layer 1907, and/or a softmax layer 1909. The final encoder output from a last encoder self-attention sub-layer 1901 of the encoder and/or an additional combined representation from a previous time step, can be processed using a first decoder sub-network 1903, to generate one or more decoder self-attention sub-layer outputs. The one or more decoder self-attention sub-layer outputs of the first decoder sub-network 1903 can be combined and normalized by an additional add&norm layers 1902 (as described above), to generate a first decoder output. Optionally, the first decoder output can be processed using additional decoder sub-network(s) 1903, if there is any, to generate a final decoder output. The final decoder output can be processed using a feed-forward layer 1905 and/or a further add&norm layers 1902. The feed-forward layer 1905 can be configured to operate on each position of a user input in a sequence of user inputs (e.g., by applying a sequence of transformations), to generate an output for the position.

The linear layer 1907 can be configured to apply a learned linear transformation to an output from the last decoder sub-network of the decoder of the LLM 190A, to project such output into an appropriate space for processing by the softmax layer 1909. The softmax layer 1909 can be configured to generate a probability distribution (“model output 172”) over a plurality of possible outputs at each time step. Based on the probability distribution, a possible output having a highest probability can be selected from the plurality of possible outputs, to generate a portion of response 143.

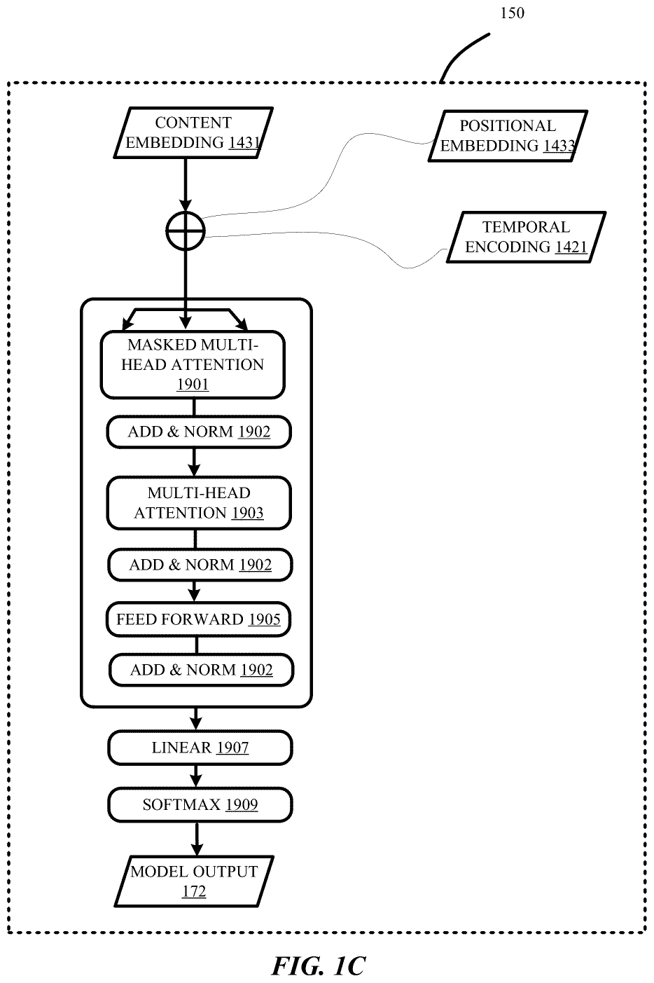

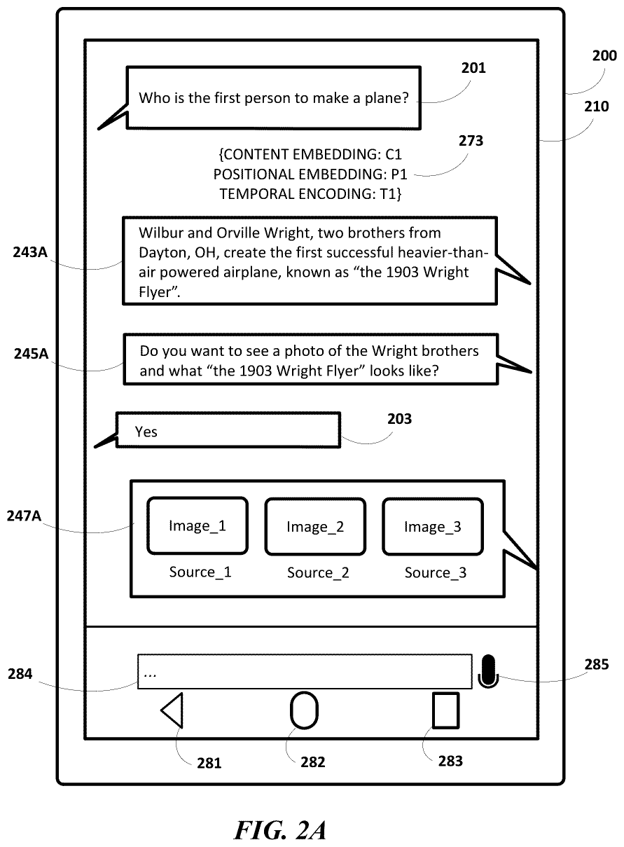

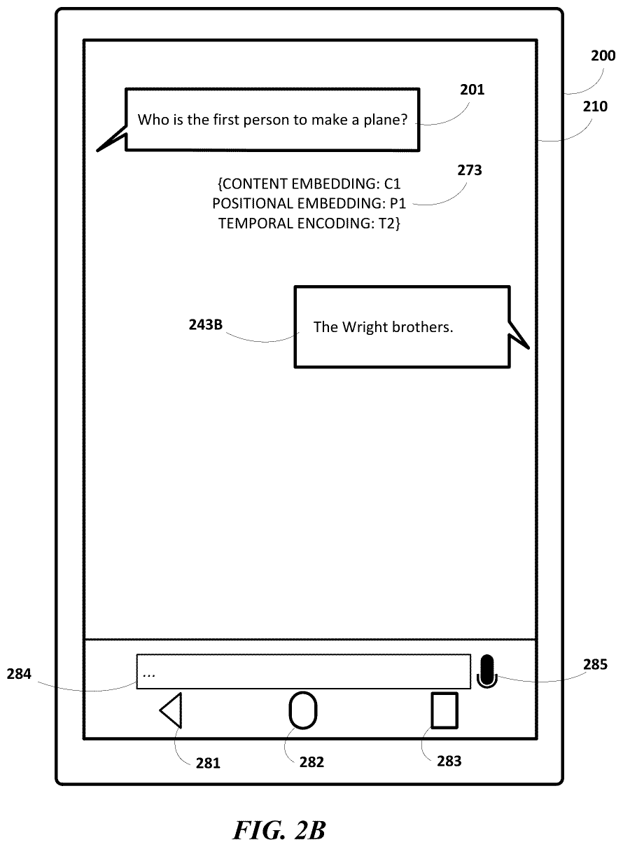

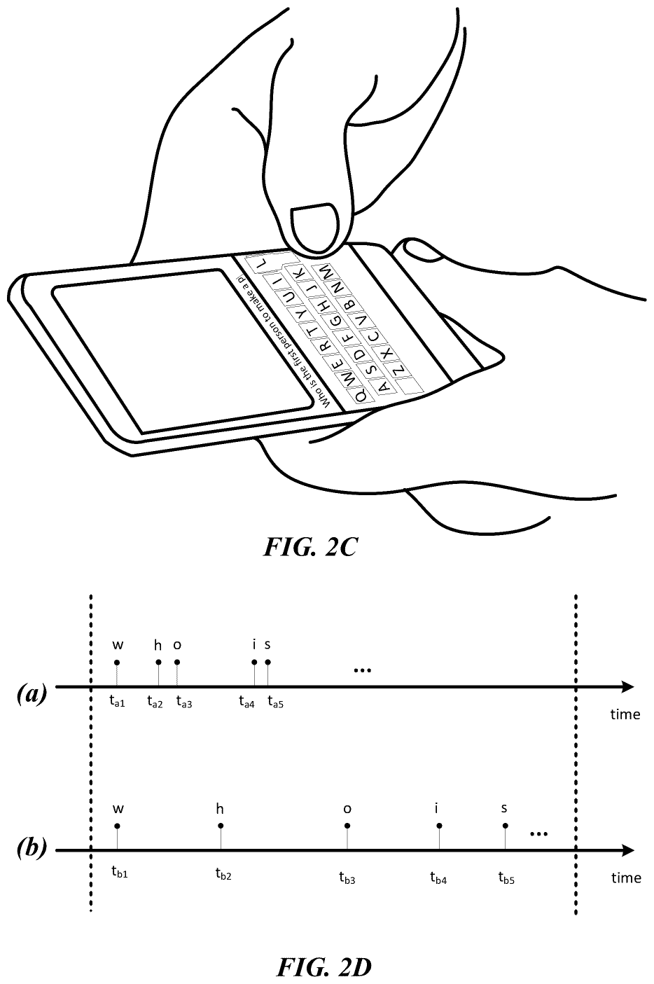

FIG. 2A depicts an example of human-to-computer dialog where a first response is generated in response to a user query, in accordance with various aspects of the present disclosure. As shown in FIG. 2A, a user (e.g., user A) can provide a user query 201 via a user interface 210 of an LLM-based assistant. The user interface 210 of the LLM-based assistant can be rendered via a client device 200. As a non-limiting example, the user query 201 can be “Who is the first person to make a plane?” Input event(s) associated with the user query 201 can be determined and processed. For instance, time intervals/delays between each adjacent two characters in the user query 201 can be determined, and a temporal encoding T1 can be generated, e.g., using the temporal encoding determination engine 120, to encode the time intervals between each adjacent two characters in the user query 201. The user query 201 can be processed, e.g., using the embedding generation engine 127, to generate a content embedding C1 that encodes content of the user query 201 and/or a positional embedding P1 that encodes relative positions between tokens or words in the user query 201.

The content embedding C1 (and/or the positional embedding P1), and the temporal encoding T1 can be utilized by a trained or fine-tuned ML model such as the LLM 190A, to generate a first response 243A. It is noted that while C1, P1, and T1 are depicted in FIG. 2A for the mere purpose of illustration, the specific content of C1, P1, and T1 (or any symbols, representations, or metadata associated therewith) may not be rendered to an end user (e.g., a human user R in FIG. 1A) via the user interface 210 during the actual human-to-computer dialog. In some implementations, the temporal encoding T1 can indicate a high level of user confidence in providing the user query 201. For instance, the temporal encoding T1 can indicate that time interval(s) between adjacent characters are below an interval threshold (which can be statistics based or user-specific), which indicates a high level of user confidence. In this case, the first response 243A can include factual or authoritative information that exceeds a certain amount (e.g., over 80% sentences of the first response 243A include one or more factual statements). For instance, as shown in FIG. 2A, the first response 243A responsive to the user query 201 can be: “Wilbur and Orville Wright, two brothers from Dayton, OH, create the first successful heavier-than-air powered airplane, known as ‘the 1903 Wright Flyer.’”

In some implementations, optionally, responsive to the high level of user confidence, the LLM-based assistant can further engage a human-to-computer dialog between the user and the LLM-based assistant by rendering an inquiry 245A (e.g., “Do you want to see a photo of the Wright brothers and what ‘the 1903 Wright Flyer’ looks like”) succeeding the first response 243A, to provide supplemental information that includes additional factual or authoritative information. Content of the inquiry 245A can depend, for instance, from content of the user query 201 and/or content of the first response 243A.

The supplemental information, for instance, can include one or more images (e.g., image_1 that shows a photo of the Wright brothers, image_2 that shows another photo of the Wright brothers, image_3 that shows the “1903 Wright Flyer”). The supplemental information can be included in a second response 247A rendered at the user interface 210 in response to receiving user confirmation 203 (e.g., “Yes”) that positively responds to the inquiry 245A. The supplemental information can further include, for instance, source(s) for the one or more images, such as source_1 for image_1, source_2 for image_2, and source_3 for image_3. It is noted that the content of the supplemental information or of the second response 247A is not limited to descriptions herein. For instance, the second response 247A can include a screenshot of text (and/or graphical) descriptions for a target object identified in the user query 201 from a reliable source that supplements content of the first response 243A.

In some implementations, as shown in FIG. 2A, the user query 201 can be received via an input field 284 rendered at the user interface 210 of the LLM-based assistant. In some other implementations, the user query 201 can be received via a microphone of the client device 200, for instance, if a graphical user interface (GUI) element representing an audio input receiving function is selected or activated. In this case, a spoken utterance detected by the microphone is actively processed to determine content of the user query 201 captured in audio data of the spoken utterance, and/or to determine temporal features associated with the user query 201. In some implementations, the user interface 210 can include one or more additional GUI elements, such as 281, 282, 283, each configured to enable a function (e.g., navigate between different user interfaces, pause a human-to-computer dialog, etc.) associated with the LLM-based assistant.

FIG. 2B depicts an example of human-to-computer dialog where a second response is generated in response to the user query in FIG. 2A, in accordance with various aspects of the present disclosure. As shown in FIG. 2B, a user (e.g., user B, or user A at a subsequent time) can provide the user query 201 via the user interface 210 of an LLM-based assistant. Input event(s) associated with the user query 201 can be determined and processed. For instance, temporal characteristics/features of the input event(s) for the user query 201, such as time intervals between each adjacent two characters in the user query 201 can be determined. In this case, a temporal encoding T2 (different from T1) can be generated, e.g., using the temporal encoding determination engine 120, to encode the time intervals between each adjacent two characters in the user query 201 as reflected by the input events from user B that deliver the user query 201. The user query 201 can be processed, e.g., using the embedding generation engine 126, to generate a content embedding C2 (in this case, the same as C1 or have a minimized distance with respect to C1 in the latent space) that encodes content of the user query 201 and a positional embedding P2 (in this case, the same as P1 or have a minimized distance with respect to P1 in the latent space) that encodes relative positions between words in the user query 201.

The content embedding C1, the positional embedding P1, and the temporal encoding T2 can be utilized by the trained or fine-tuned ML model such as the LLM 190A, to generate a response 243B. In some implementations, the temporal encoding T2 can indicate a low level of user confidence in providing the user query 201. For instance, the temporal encoding T2 can indicate that time interval(s) between adjacent characters (or a certain portion of characters present in the user query 201) exceed an interval threshold, which indicates a low level of user confidence of the user B in providing the user query 201 (or a portion thereof). In this case, the second response 243B can include none or a short factual statement. For instance, as shown in FIG. 2B, the second response 243B responsive to the user query 201 can be: “the Wright brothers.” In some implementations, optionally, as the input events indicate a low level of user confidence, no inquiry seeking user permission to present supplemental information that includes additional factual or authoritative information is provided succeeding the second response 243B.

It is noted that, scenarios depicted in FIG. 2A and FIG. 2B are not intended to be limiting. For instance, instead of responding with a short factual statement as depicted in FIG. 2B, the trained (or fine-tuned) ML model can be trained (or fine-tuned) to generate model output from which one or more portions are derived in response to the user query 201. The one or more portions can provide a short statement (e.g., “The Wright brothers”) responsive to the user query 201 and one or more links related to “The Wright brothers”. Optionally, it is noted that, techniques described herein may be utilized to determine, based on temporal characteristics associated with input event(s) for the user query 201 indicating that a receiving speed for a particular portion (e.g., “first person”) of the user query 201 is below a typing speed threshold (or a spoken speed threshold) while other portions of the user query 201 is not, etc., that a user of the user query 201 is particularly confused with the particular portion. In this case, the ML model can be trained (or fine-tuned) to generate model output from which additional explanatory information (e.g., “Yes, the Wright brothers refer to Wilbur Wright and Orville Wright, they are brothers, together they created the first plane ever.”) is derived for the particular portion (e.g., “first person”), in addition to the short statement of “The Wright brothers”. Alternatively or additionally, the ML model can be trained (or fine-tuned) to generate model output from which a recommended action (e.g., search for “the Wright brothers”) is derived, in addition to a textual response (e.g., the short statement, such as “The Wright brothers”). The recommended action is determined based on the particular portion and can be rendered as a selectable graphical user interface (GUI) element which, when selected by the user, causes the recommended action of searching for “the Wright brothers” to be performed.

FIG. 2C depicts an example of typing events, in accordance with various aspects of the present disclosure. As shown in FIG. 2C, the typing events can include user touch of one or more virtual keys (e.g., a virtual key to receiving user input of character “L” or “I”) within a virtual keyboard displayed via the user interface 210. Based on the typing events, the user query 201 can be determined or updated. As a non-limiting example, the user query 201, as shown in FIG. 2C, can include, “Who is the first person to make a pl . . . ” As the user continues typing, the user query 201 can become a complete query (e.g., “Who is the first person to make a plane?”).

In some implementations, typing event(s) (or other input events, such as utterance event, etc.) associated with an incomplete user input (typed, audible, etc.) can be monitored and utilized to determine a user intent or a level of user confidence. For instance, if the typing event(s) of the incomplete user query, e.g., “Who is the first person to make a pl . . . ” in FIG. 2C indicate a low level of user confidence, the generative model 190A can process a combined representation that combines a content embedding for the incomplete user query (and/or a positional embedding for relative positions of tokens determined from the incomplete user query), and a temporal encoding that encodes temporal features for the incomplete user query, to determine one or more options. The one or more options can each supplement the incomplete user query and/or provide a response to the incomplete user query.

For instance, the generative model 190A can generate, based on processing the combined representation, a model output from which a first option and a second option are derived. In some implementations, the first option can be one or more characters such as “ane” that completes the incomplete user query “Who is the first person to make a pl . . . ” into a complete user query of “Who is the first person to make a plane”. The second option can be one or more characters such as “ay” that completes the incomplete user query “Who is the first person to make a pl . . . ” into a complete user query of “Who is the first person to make a play”. In some implementations, the model output of the generative model 190A that corresponds to the combined representation for the incomplete user query (e.g., “Who is the first person to make a pl . . . ”) can include a plurality of probabilities. The plurality of probabilities can include a first probability predicted for the first option showing characters of “ane” that complete the incomplete user query “Who is the first person to make a pl . . . ” into the complete user query of “Who is the first person to make a plane”, and include a second probability predicted for the second option showing characters of “an” that complete the incomplete user query “Who is the first person to make a pl . . . ” into the complete user query of “Who is the first person to make a play”. Optionally, the first and second options can be rendered as selectable graphical user interface (GUI) elements that, when selected, causes the incomplete user query to be completed in a manner consistent with the selected option (e.g., the first or second option).

In some implementations, alternatively or additionally, the first option can include an instant response (“Wright brothers”) responsive to the incomplete user query “Who is the first person to make a pl . . . ” based on a predicted complete user query of “Who is the first person to make a plane”. The second option can include a different instance response (e.g., “Aeschylus”) responsive to the incomplete user query “Who is the first person to make a pl . . . ” based on a predicted complete user query of “Who is the first person to make a play”. In this case, the first and second options can vary dynamics as the user continues providing additional typing event(s) that modifies the incomplete user query of “Who is the first person to make a pl . . . ”.

FIG. 2D depicts examples of a time sequence (a) showing character-level time intervals between different characters determined from typing events for the user input 201 in FIG. 2A and another time sequence (b) showing character-level time intervals between different characters determined from typing events for the user input 201 in FIG. 2B. As shown in FIG. 2D, a typing input rate for the user query 201 in FIG. 2A can be higher than a typing input rate for the user query 201 in FIG. 2B, indicating a higher level of user confidence for the user query 201 in FIG. 2A. In this case, more authoritative information can be included in the first response 243A as compared to the authoritative information included in the response 243B.

In some implementations, referring to time sequence (a) in FIG. 2D, time intervals (tₐ₂-tₐ₁, tₐ₃-tₐ₂, etc.) between two adjacent characters can be determined for input events that provide the user query 201 in FIG. 2A and user input. The time intervals can be determined, for instance, based on a receiving time for each character in the user query 201 in FIG. 2A (e.g., tai for the character “w”, tₐ₂ for the character “h”, tₐ₃ for the character “o”, tₐ₄ for the character “i”, and tₐ₅ for the character “s”, etc.). In some implementations, referring to time sequence (b) in FIG. 2D, time intervals (t_{b2}-t_{b1}, t_{b3}-t_{b2}, etc.) between two adjacent characters can be determined for input events that provide the user query 201 in FIG. 2B and user input. Such time intervals can be determined, for instance, based on a receiving time for each character in the user query 201 in FIG. 2B (e.g., t_{b1} for the character “w”, t_{b2} for the character “h”, t_{b3} for the character “o”, t_{b4} for the character “i”, and t_{b5} for the character “s”, etc.) Without determining and considering typing events associated with the user query 201 or the temporal features extracted therefrom, the response 243B generated using the generative model 190A in response to the same user query 201 maybe the same as the first response 243A, which may lead to excessive consumption of computational resources.

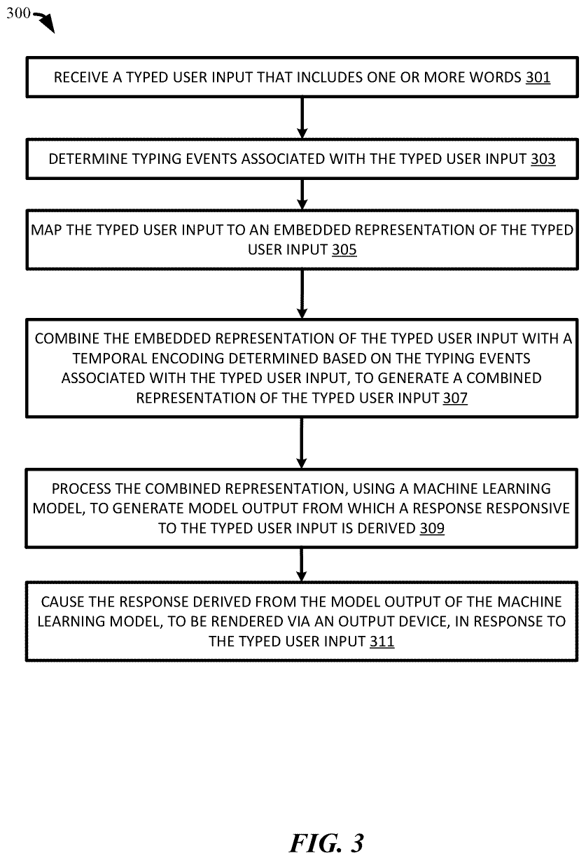

FIG. 3 depicts an example of a response generated using a trained generative model and considering a user intent reflected from typing events associated with typed user input, in accordance with various aspects of the present disclosure. As shown in FIG. 3, the system receives a typed user input that includes one or more words (block 301). In some implementations, the system determines/retrieves typing events associated with the typed user input (block 303).

The typed user input can be received, for instance, at an input device. For example, the input device can be a physical keyboard, and the system can detect an initiation of the typed user input via one or more sensors coupled to the physical keyboard. In some implementations, the aforementioned input event determination engine 124 can be configured to monitor and/or record input event(s) associated with the typed user input. In some implementations, the input event(s) can be typing events describing a receiving time for each character in the typed user input. In some implementations, the input event(s) can include typing events indicating a deletion of a character, a receiving time at which the input device receives the character, and/or a deleting time at which the character is deleted from being included in the typed user input.

In some implementations, the system maps the typed user input to an embedded representation (sometimes referred to as “content embedding” or “content representation”) of the typed user input (block 305). The embedded representation of the typed user input, for instance, can be an N-dimensional numeric vector that stores a total number of N floating numbers that encodes word content of the typed user input.

In some implementations, the system combines the embedded representation of the typed user input with a temporal encoding determined based on the typing events associated with the typed user input, to generate a combined representation of the typed user input (block 307). Optionally, the combined representation can be generated further based on a positional embedding that encodes positions of the one or more words in the typed user input. In other words, the system can combine the embedded representation of the typed user input with the positional embedding that encodes positions of the one or more words in the typed user input, as well as the temporal encoding determined based on the typing events associated with the typed user input, to generate the combined representation of the typed user input.

In some implementations, the positional embedding can be an additional N-dimensional numeric vector that stores a total number of N floating numbers that encodes positional information of all words present in the typed user input. In some implementations, the temporal encoding can be a further N-dimensional numeric vector that stores a total number of N floating numbers that encodes temporal features determined from the typing events of the typed user input.

In some implementations, the system processes the combined representation, using a machine learning model (e.g., LLM 190A), to generate model output from which a response responsive to the typed user input is derived (block 309).

The machine learning model can be, for instance, a generative model. The generative model can be, for instance, a large language model (“LLM”). The LLM can have less than 100 billion parameters, more than 100 billion parameters, or over 200 billion parameters, etc. The greater the number of parameters of the LLM, the more complex (or sophisticated) a task (e.g., specified in a user query or request) the LLM can handle. In some implementations, the LLM may be stored at a client device having the input device, or at a server computing device in communication with the client device. In some implementations, the LLM may be trained using enormous amounts of data collected from diverse sources such as webpages, electronic books, software code, electronic news articles, and machine translation data. In some implementations, the LLM can be fine-tuned or customized using training instances (e.g., 180 in FIG. 1B) so that responses generated using the fine-tuned LLM can vary for user queries having the same content (e.g., word content) but are associated with different user intents (as reflected by the typing events associated with the typed user input).

In some implementations, the system causes the response to be rendered via an output device, in response to the typed user input (block 311). The response can be rendered audibly and/or visually.

In some implementations, depending on content of the typed user input, the response can include a recommended action (instead of or in addition to textual descriptions). The recommended action can vary depending on the temporal encoding even for typed user inputs having the same content but are created using different typed events.

In some implementations, the system determines the typing events associated with the typed user input by: determining a receiving time for each character in the one or more words at the input device. In some implementations, the temporal encoding determined based on the typing events is an inter-character temporal encoding that encodes time intervals between each two adjacent characters in the typed user input.

In some implementations, the system determines typing events associated with the typed user input by determining a typing speed of the typed user input (or a portion thereof). In some implementations, the temporal encoding determined based on the typing events encodes the typing speed of the typed user input. The typing speed can be an average typing speed of the typed user input (or a portion thereof). The typing speed can alternatively be a dynamic speed that varies for different portions of the typed user input, and the present disclosure is not limited herein.

In some implementations, content of the response varies in dependence on the temporal encoding. In some implementations, the response can include more authorized content when the temporal encoding indicates a high user confidence in the typed user input, and include less authorized content when the temporal encoding indicates a lower user confidence in the typed user input. Alternatively or additionally, the response for the high level of user confidence can be of an extended length (e.g., including more than a predefined number of sentences, such as more than two sentences). For example, the response generated for the high level of user confidence can include at least a predefined number of factual statements or authoritative statements. Alternatively or additionally, the response for the low level of user confidence can be of a limited length (e.g., including a single sentence or clause having less than a certain amount of words or characters).

In some implementations, the machine learning model includes a decoder having one or more decoder sub-networks as described above. A model output of the machine learning model can be text-token specific, and/or include a probability distribution for a plurality of tokens. In some implementations, the machine learning model includes an encoder having one or more encoder sub-networks as described above.

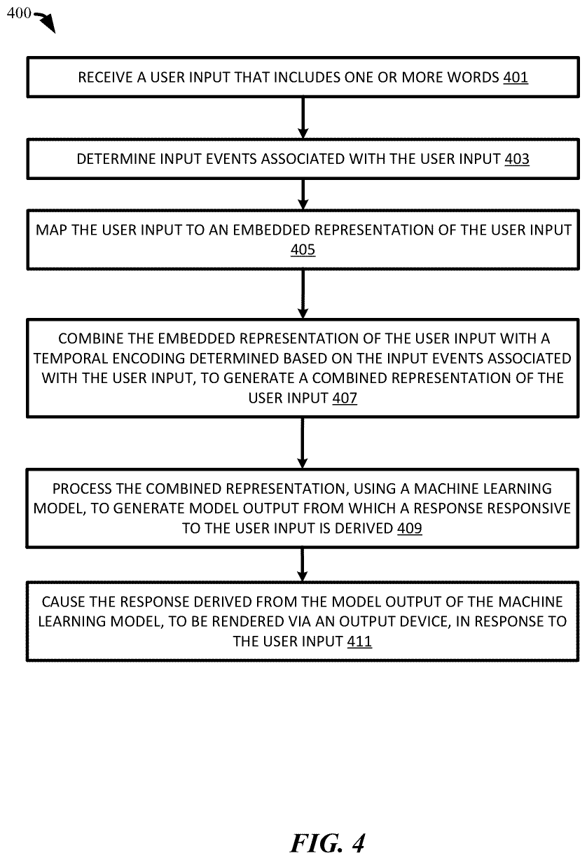

Turning now to FIG. 4, a flowchart illustrating a method of generating a response using a generative model, in accordance with various aspects of the present disclosure. A system for performing the method 400 includes one or more processors, memory, and/or other component(s) of computing device(s) (e.g., client computing device 10 of FIG. 1, one or more servers, and/or other computing devices). Moreover, while operations of the method 400 are shown in a particular order, this is not meant to be limiting. One or more operations may be reordered, omitted, and/or added.

At block 401, the system receives a user input that includes one or more words and that is received via an input device (block 401). In some implementations, the system determines input event(s) associated with the user input (block 403). In some implementations, the input event(s) can be, or can include, for instance, one or more typing events where each typing event triggers detection of a character typed by a user that provides the user input. In some implementations, the input event(s) can be or can include, for instance, one or more spoken utterances, where each spoken utterance provides a portion of the user input. In some implementations, the input event(s) can be or can include, for instance, one or more gestures. In some implementations, the input event(s) can be or can include, for instance, one or more motions. There can be other types of input event(s), and the present disclosure is not limited thereto.

In some implementations, the system maps the user input to an embedded representation of the user input (block 405). In some implementations, content (e.g., word content) of the user input can be determined from the input event(s), and the content of the user input can be mapped to the embedded representation of the user input in a latent space. The embedded representation can be referred to as “content embedding”, “input embedding”, etc., and can be a N-dimensional numeric vector as described elsewhere in this disclosure. As a non-limiting example, the content of the user input can be “tell me more about section 101 in patent law”, which can be determined from typing events (or utterance events, etc.) of a user. Such content of the user input can be processed to determine a corresponding embedded representation C in the latent space, where the embedded representation C encodes word content of the user input of “tell me more about section 101 in patent law”.

In some implementations, the system combines the embedded representation (“C”) of the user input with a temporal encoding (“T”) determined based on the input events associated with the user input, to generate a combined representation of the user input (block 407). In some implementations, the temporal encoding T can be determined based on temporal features extracted from the input event(s) associated with the user input. For instance, the temporal encoding T can be generated based on processing temporal features/characteristics of the user input, such as time intervals between each two characters (or phonemes, words, etc.) present in the user input.

In some implementations, the combined representation can be further determined based on a positional embedding (“P”) that encodes positions of the one or more tokens or words in the user input. In some implementations, the temporal encoding T and the positional embedding P can also be in the form of an N-dimensional numeric vector. It is noted that the embedded representation C, the temporal encoding T, and the positional embedding P may not necessarily need to be rendered visually to a display of a client device that the input device is coupled to.

In some implementations, the system processes the combined representation, using a machine learning model, to generate model output from which a response responsive to the user input is derived (block 409). In some implementations, the system causes the response to be rendered (block 411). It is noted that for different input events that provide user inputs having the same content but have different temporal features (thus reflecting different user intents or confidence levels), different responses can be generated using the machine learning model based on processing the aforementioned combined representation that takes into consideration the different temporal features respectively extracted from the different input events. For instance, continuing with the non-limiting example above, content of user input can be determined as “tell me about section 101 in patent law” for different occurrences of input events.

For instance, a first occurrence of input event(s) can be provided by a first user typing in “tell me about section 101 in patent law”, and the first occurrence of input event(s) can indicate that a first typing speed is a relatively fast typing speed (e.g., faster than a typing speed for an average person, or faster than a recorded typing speed for the first user as reflected in a user profile of the first user). A second occurrence of input event(s) can provided by a second user typing in “tell me about section 101 in patent law”, and the second occurrence of input event(s) can indicate that a typing speed for a portion of the user input (e.g., “section 101”) is relatively slow (e.g., below a normal typing speed for an average person or for the second user). A third occurrence of input event(s) can provided by a third user typing in “tell me about section 101 in patent law”, and the third occurrence of input event(s) can indicate that a typing speed for another portion of the user input (e.g., “patent law”) is relatively slow (e.g., below a normal typing speed for an average person or for the second user).

In the above case, a first response can be generated using the generative model (e.g., LLM 190A) in response to receiving the first occurrence of input event(s), a second response can be generated using the generative model (e.g., LLM 190A) in response to receiving the second occurrence of input event(s), and a third response can be generated using the generative model (e.g., LLM 190A) in response to receiving the third occurrence of input event(s). The first, second, and third responses can be different from one another. For instance, the first response can include more authoritative or factual information as compared to the second and third responses. As another example, additionally or alternatively, the second response can include a broad overview for a portion (e.g., “101 section”) of the user input that shows a typing speed slower than usual, and/or one or more options to the user to selectively further explore information for such portion (e.g., “101 section”). Additionally or alternatively, the second response can include a broad overview for a different portion (e.g., “patent law”) of the user input that shows a typing speed slower than usual, and/or one or more options to the user to selectively further explore information for the different portion (e.g., “patent law”).

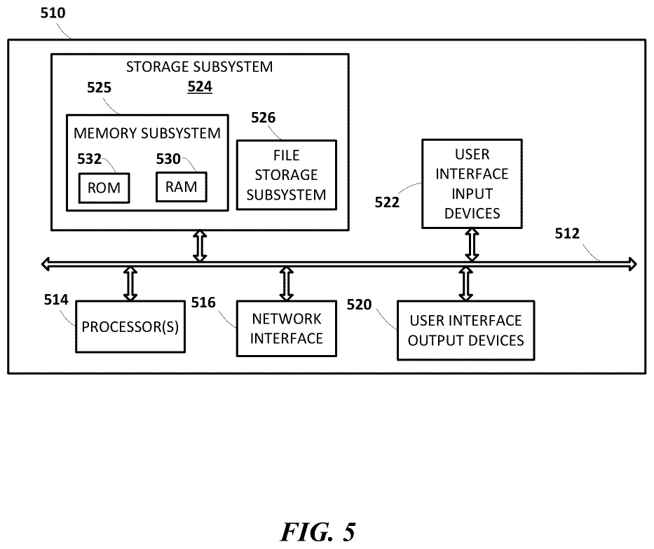

Turning now to FIG. 5, a block diagram of an example computing device 510 that may optionally be utilized to perform one or more aspects of techniques described herein is depicted. In some implementations, one or more of a client device, cloud-based LLM-based assistant component(s), and/or other component(s) may comprise one or more components of the example computing device 510.

Computing device 510 typically includes at least one processor 514 which communicates with a number of peripheral devices via bus subsystem 512. These peripheral devices may include a storage subsystem 524, including, for example, a memory subsystem 525 and a file storage subsystem 526, user interface output devices 520, user interface input devices 522, and a network interface subsystem 516. The input and output devices allow user interaction with computing device 510. Network interface subsystem 516 provides an interface to outside networks and is coupled to corresponding interface devices in other computing devices.

User interface input devices 522 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 510 or onto a communication network.

User interface output devices 520 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 510 to the user or to another machine or computing device.

Storage subsystem 524 stores programming and data constructs that provide the functionality of some or all of the modules described herein. For example, the storage subsystem 524 may include the logic to perform selected aspects of the methods disclosed herein, as well as to implement various components depicted in FIG. 1.

These software modules are generally executed by processor 514 alone or in combination with other processors. Memory 525 used in the storage subsystem 524 can include a number of memories including a main random access memory (RAM) 530 for storage of instructions and data during program execution and a read only memory (ROM) 532 in which fixed instructions are stored. A file storage subsystem 526 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 526 in the storage subsystem 524, or in other machines accessible by the processor(s) 514.

Bus subsystem 512 provides a mechanism for letting the various components and subsystems of computing device 510 communicate with each other as intended. Although bus subsystem 512 is shown schematically as a single bus, alternative implementations of the bus subsystem 512 may use multiple busses.

Computing device 510 can be of varying types including a workstation, server, computing cluster, blade server, server farm, or any other data processing system or computing device. Due to the ever-changing nature of computers and networks, the description of computing device 510 depicted in FIG. 5 is intended only as a specific example for purposes of illustrating some implementations. Many other configurations of computing device 510 are possible having more or fewer components than the computing device depicted in FIG. 5.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

Some other implementations disclosed herein recognize that training a generative model can require a significant quantity (e.g., millions) of training instances. Due to the significant quantity of training instances needed, many training instances will lack input and/or output properties that are desired when the generative model is deployed for utilization. For example, some training instance outputs for an LLM can be undesirably grammatically incorrect, undesirably too concise, undesirably too robust, etc. Also, for example, some training instance inputs for an LLM can lack desired contextual data such as user attribute(s) associated with the input, conversational history associated with the input, etc. As a result of many of the LLM training instances lacking desired input and/or output properties, the LLM will, after training and when deployed, generate many instances of output that likewise lack the desired output properties.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more transitory or non-transitory computer readable storage media storing computer instructions executable by one or more processors to perform any of the aforementioned methods. Some implementations also include a computer program product including instructions executable by one or more processors to perform any of the aforementioned methods.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, and/or method described herein. In addition, any combination of two or more such features, systems, and/or methods, if such features, systems, and/or methods are not mutually inconsistent, is included within the scope of the present disclosure.

In various implementations, a computer-implemented method is provided, the method can include: receiving a typed user input that includes one or more words and that is typed at an input device; determining one or more typing events for the typed user input, wherein the one or more typing events indicate one or more temporal characteristics of typing of the typed user input; generating a combined representation that combines an embedded representation of the typed user input and a temporal encoding that is determined based on the typing events for the typed user input; processing the combined representation, using a machine learning model, to generate model output from which a response responsive to the typed user input is derived; and causing the response, derived from the model output of the machine learning model, to be rendered via an output device in response to the typed user input.

In some of the various implementations, determining typing events associated with the typed user input can include: determining a receiving time for each character in the one or more words at the input device. In some of the various implementations, the temporal encoding determined based on the typing events is an inter-character temporal encoding that encodes time intervals between each pair of adjacent characters in the typed user input.

In some of the various implementations, determining typing events associated with the typed user input can include: determining a typing speed of the typed user input. In some of the various implementations, the temporal encoding determined based on the typing events encodes the typing speed of the typed user input.

In some of the various implementations, the combined representation further includes a positional encoding that encodes positions of the one or more words in the user input.

In some of the various implementations, the machine learning model is trained to cause generation of more authoritative content when the temporal encoding indicates a high user confidence in the typed user input, and to cause generation of less authoritative content when the temporal encoding indicates a lower user confidence in the typed user input.

In some of the various implementations, the machine learning model is a sequence-to-sequence model that includes a decoder with one or more attention layers, and wherein the model output includes a sequence of probability distributions over a vocabulary of tokens.

In some of the various implementations, the method further includes: receiving an additional typed user input that includes the same one or more words as the typed user input; determining one or more alternative typing events for the additional typed user input, wherein the one or more alternative typing events indicate one or more alternative temporal characteristics, of typing of the additional typed user input, that differ from the one or more temporal characteristics of the typed user input; generating an alternative combined representation that combines the embedded representation of the additional typed user input and an alternative temporal encoding that is determined based on the alternative typing events for the additional typed user input; processing the alternative combined representation, using a machine learning model, to generate alternative model output from which an alternative response responsive to the typed user input is derived; and causing the alternative response, derived from the model output of the machine learning model, to be rendered in response to the additional typed user input.

In various implementations, a computer-implemented method is provided. The method includes: receiving a user input that includes one or more words and that is provided via an input device; determining input events for the user input, wherein the input events indicate one or more temporal characteristics of providing of the user input; generating a combined representation that combines an embedded representation of the user input with a temporal encoding determined based on the input events for the user input; processing the combined representation, using a machine learning model, to generate model output from which a response responsive to the user input is derived; and causing the response derived from the model output of the machine learning model, to be rendered via an output device, in response to the user input.

In some of the various implementations, the user input is a typed user input. In this case, determining input events associated with the user input can include: determining a receiving time for each character in the one or more words at the input device. In some implementations, the temporal encoding determined based on the input events is an inter-character temporal encoding that encodes time intervals between each two adjacent characters in the typed user input. In some implementations, determining the input events for the user input can include: determining a typing speed of the typed user input. In some implementations, the temporal encoding determined based on the input events encodes the typing speed of the typed user input. In some implementations, content of the response varies in dependence on the temporal encoding. For example, in some implementations, the response includes more authoritative content when the temporal encoding indicates a high user confidence in the user input, and includes less authoritative content when the temporal encoding indicates a lower user confidence in the user input.

In some of the various implementations, the machine learning model includes a decoder, and the model output is text-token specific.

In some of the various implementations, the response includes a recommended action that varies in dependence on the temporal encoding.

In some of the various implementations, the user input is a spoken user input. In some implementations, the temporal encoding determined based on the input events is an inter-phoneme temporal encoding that encodes time intervals between each two adjacent phonemes in the spoken user input. In some implementations, determining the input events for the user input can include: determining a spoken rate of the spoken user input. In some implementations, the temporal encoding determined based on the input events encodes the spoken rate of the spoken user input. In some implementations, content of the response varies in dependence on the temporal encoding. For example, in some implementations, the response includes more authoritative content when the temporal encoding indicates a high user confidence in the user input, and includes less authoritative content when the temporal encoding indicates a lower user confidence in the user input.

In some of the various implementations, the user input is a touch user input. In this case, determining input events associated with the user input can include: determining a receiving time for each character in the one or more words at the input device. In some implementations, the temporal encoding determined based on the input events is an inter-character temporal encoding that encodes time intervals between each two adjacent characters in the touch user input. In some implementations, content of the response varies depending on the temporal encoding. For example, in some implementations, the response includes more authoritative content when the temporal encoding indicates a high user confidence in the user input, and includes less authoritative content when the temporal encoding indicates a lower user confidence in the user input.

In various implementations, a system is provided. The system can include one or more processors and memory storing instructions that, when executed, cause the one or more processors to: receive, via an input device, a user input that includes one or more words; determine input events associated with the user input; map the user input to an embedded representation of the user input; combine the embedded representation of the user input with a positional embedding that encodes positions of the one or more words in the user input and a temporal encoding determined based on the input events associated with the user input, to generate a combined representation of the user input; process the combined representation, using a machine learning model, to generate model output from which a response responsive to the user input is derived; and cause the response derived from the model output of the machine learning model, to be rendered via an output device, in response to the user input.

What is claimed is:

1. A computer-implemented method, the method comprising:
receiving a typed user input that includes one or more words and that is typed at an input device;
determining one or more typing events for the typed user input, wherein the one or more typing events indicate one or more temporal characteristics of typing of the typed user input;
generating a combined representation that combines an embedded representation of the typed user input and a temporal encoding that is determined based on the typing events for the typed user input;
processing the combined representation, using a machine learning model, to generate model output from which a response responsive to the typed user input is derived; and
causing the response, derived from the model output of the machine learning model, to be rendered via an output device in response to the typed user input.

2. The method of claim 1, wherein determining typing events associated with the typed user input comprises:
determining a receiving time for each character in the one or more words at the input device.

3. The method of claim 2, wherein the temporal encoding determined based on the typing events is an inter-character temporal encoding that encodes time intervals between each pair of adjacent characters in the typed user input.

4. The method of claim 1, wherein determining typing events associated with the typed user input comprises:
determining a typing speed of the typed user input.

5. The method of claim 4, wherein the temporal encoding determined based on the typing events encodes the typing speed of the typed user input.

6. The method of claim 1, wherein the combined representation further includes a positional encoding that encodes positions of the one or more words in the user input.

7. The method of claim 1, wherein the machine learning model is trained to cause generation of more authoritative content when the temporal encoding indicates a high user confidence in the typed user input, and to cause generation of less authoritative content when the temporal encoding indicates a lower user confidence in the typed user input.

8. The method of claim 1, wherein the machine learning model is a sequence-to-sequence model that includes a decoder with one or more attention layers, and wherein the model output includes a sequence of probability distributions over a vocabulary of tokens.

9. The method of claim 1, further comprising:
receiving an additional typed user input that includes the same one or more words as the typed user input;
determining one or more alternative typing events for the additional typed user input, wherein the one or more alternative typing events indicate one or more alternative temporal characteristics, of typing of the additional typed user input, that differ from the one or more temporal characteristics of the typed user input;
generating an alternative combined representation that combines the embedded representation of the additional typed user input and an alternative temporal encoding that is determined based on the alternative typing events for the additional typed user input;
processing the alternative combined representation, using a machine learning model, to generate alternative model output from which an alternative response responsive to the typed user input is derived; and
causing the alternative response, derived from the model output of the machine learning model, to be rendered in response to the additional typed user input.

10. A computer-implemented method, the method comprising:
receiving a user input that includes one or more words and that is provided via an input device;
determining input events for the user input, wherein the input events indicate one or more temporal characteristics of providing of the user input;
generating a combined representation that combines an embedded representation of the user input with a temporal encoding determined based on the input events for the user input;
processing the combined embedded representation, using a machine learning model, to generate model output from which a response responsive to the user input is derived; and
causing the response derived from the model output of the machine learning model, to be rendered via an output device, in response to the user input.

11. The method of claim 10, wherein the user input is a typed user input, and wherein determining input events associated with the user input comprises:
determining a receiving time for each character in the one or more words at the input device.

12. The method of claim 11, wherein the temporal encoding determined based on the input events is an inter-character temporal encoding that encodes time intervals between each two adjacent characters in the typed user input.

13. The method of claim 11, wherein determining the input events for the user input comprises: determining a typing speed of the typed user input.

14. The method of claim 13, wherein the temporal encoding determined based on the input events encodes the typing speed of the typed user input.

15. The method of claim 10, wherein content of the response varies in dependence on the temporal encoding.

16. The method of claim 15, wherein the response includes more authoritative content when the temporal encoding indicates a high user confidence in the user input, and includes less authoritative content when the temporal encoding indicates a lower user confidence in the user input.

17. The method of claim 10, wherein the machine learning model includes a decoder, and the model output is text-token specific.

18. The method of claim 10, wherein the response includes a recommended action that varies in dependence on the temporal encoding.

19. The method of claim 10, wherein the user input is a spoken user input, or a touch user input.

20. A system comprising one or more processors and memory storing instructions that, when executed, cause the one or more processors to:
receive, via an input device, a user input that includes one or more words;
determine input events associated with the user input;
map the user input to an embedded representation of the user input;
combine the embedded representation of the user input with a positional embedding that encodes positions of the one or more words in the user input and a temporal encoding determined based on the input events associated with the user input, to generate a combined representation of the user input;
process the combined representation, using a machine learning model, to generate model output from which a response responsive to the user input is derived; and
cause the response derived from the model output of the machine learning model, to be rendered via an output device, in response to the user input.
